(19) United States
(12) Patent Application Publication
(10) Pub. No.: US 2016/0251137 A1
(43) Pub. Date: Sep. 1, 2016

(54) Storage Container with Expandable Medium

(71) Applicant: SUNBEAM PRODUCTS, INC., Boca Raton, FL (US)

(72) Inventor: Eric Forti, Boynton Beach, FL (US)

(73) Assignee: Sunbeam Products, Inc., Boca Raton, FL (US)

(21) Appl. No.: 14/766,231

(22) PCT Filed: Feb. 12, 2015
(86) PCT No.: PCT/US15/15539

§ 371 Date: Aug. 6, 2015

Related U.S. Application Data
(60) Provisional application No. 61/938,997, filed on Feb. 12, 2014.

(51) Int. Cl. B65D 79/00; A23L 3/3418; B65B 31/00; B65D 41/04; B65D 81/20

(52) U.S. Cl. CPC B65D 79/005; B65D 41/04; B65D 81/2015; B65D 81/2038; B65B 31/00; A23L 3/3418; A23V 2002/00

(57) ABSTRACT

A food preservation container and related method of use is provided. The food preservation container includes a body including at least one sidewall and having an interior volume. There is a lid for removably attaching to the body for sealing the food preservation container in an air and liquid tight manner. An expandable medium is attached to the lid, the expandable medium includes a plurality of gussets normally in a compacted configuration against the lid. A port is formed in the at least one sidewall configured to connect to a source of suction. The suction is for evacuating the container and causing the expandable medium to expand away from the lid and into the interior volume. The expandable medium may be viewed through the sidewall of the body or from the exterior of the lid to provide a visual indication of whether the food preservation container is evacuated.

### CROSS-REFERENCE TO RELATED APPLICATION

The present application claims priority to U.S. Provisional Patent Application No. 61/938,997 filed Feb. 12, 2014, entitled “Expandable Vacuum Canister Lid”.

### FIELD OF THE INVENTION

The invention relates to preservation of perishable items. More particularly, the invention relates to an improved storage container for storing perishable items such as food with an integrated expandable medium that extends from the lid into the storage container when evacuated to aid in evacuation and to provide a visual indicator of evacuation.

### BACKGROUND OF THE INVENTION

Storage containers used to preserve perishable items such as food are known in the art. Such storage containers protect the perishable items from the spoiling effects of oxygen in air. It is also known to evacuate the interior of the storage container of air using a vacuum source fluidly connected to the storage container. Such arrangements suffer from drawbacks because all air may not be completely evacuated. Also, it is not always easy to determine when the storage container is evacuated.

### SUMMARY OF THE INVENTION

In an embodiment, there is provided a food preservation container including a body including at least one sidewall and having an interior volume, a lid for removably attaching to the body for sealing the food preservation container in an air and liquid tight manner, an expandable medium attached to the lid, the expandable medium including a plurality of gussets normally in a compacted first configuration against the lid, and a port formed in the at least one sidewall configured to connect to a source of suction. The suction is for evacuating the container and causing the expandable medium to expand away from the lid and into the interior volume to an expanded second configuration.

In an embodiment, there is provided a method of preserving perishable items including the steps of evacuating air from a sealed storage container having an interior volume containing a perishable item to be preserved, expanding an expandable medium into the interior volume attached to a lid of the storage container, and verifying the storage container has been evacuated by visually observing whether the expandable medium has been expanded into the interior volume.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a perspective view of an embodiment of an improved vacuum food storage container with an expandable medium on the lid connected to a vacuum packaging appliance;

FIG. 2 is a front perspective view of the food storage container of FIG. 1 with the lid removed;

FIG. 3 is another front perspective view of the food storage container of FIG. 1 with the lid attached;

FIG. 4 is a sectional view of the food storage container of FIG. 1 in the non-evacuated configuration; and

FIG. 5 is a sectional view of the foods storage container of FIG. 1 in the evacuated configuration.

### DETAILED DESCRIPTION OF THE INVENTION

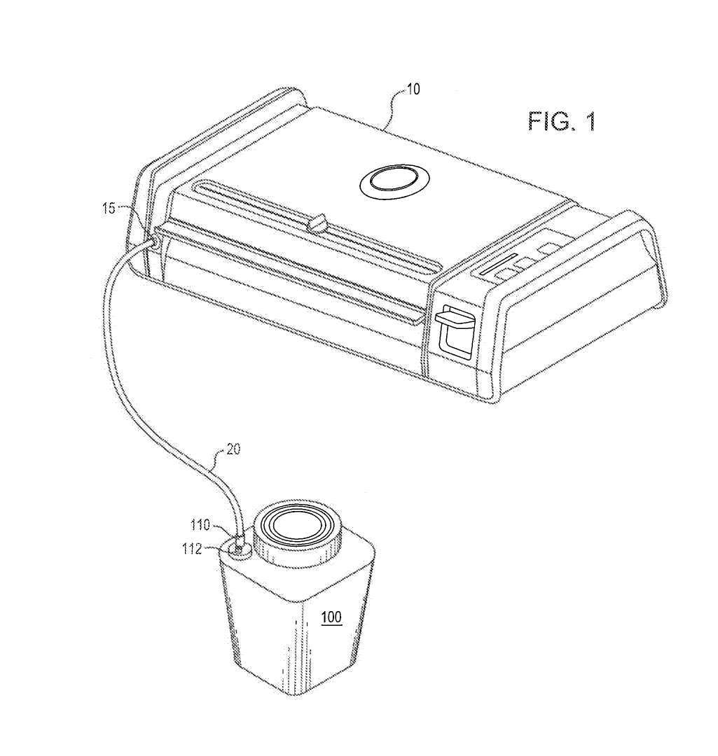

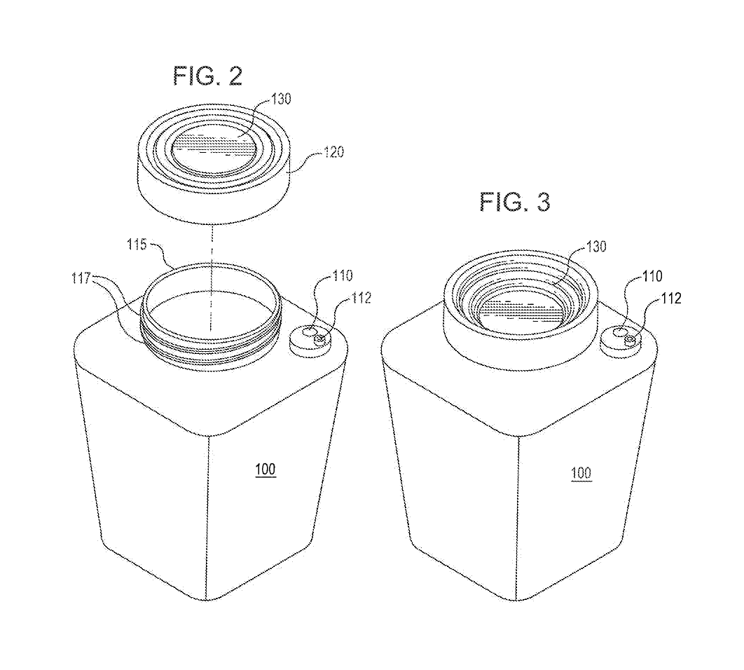

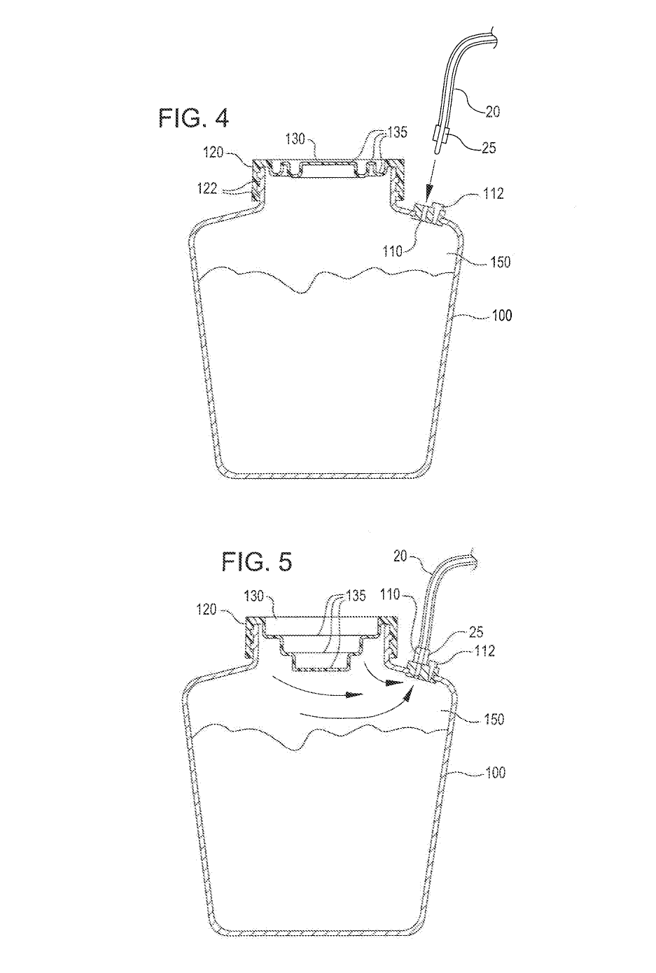

Referring now to FIGS. 1-2 of the drawings, in an embodiment there is illustrated an improved vacuum foods storage container 100 or canister for storage of perishable items including but not limited to food items. In use, the container 100 is fluidly connected by tubing 20 to a vacuum source for evacuating air containing food spoiling oxygen. In FIG. 1, vacuum source is a food storage machine including but not limited to a vacuum packaging machine 10 but the vacuum source may be from other sources such as a vacuum pump (not shown). The tubing 20 is connected to the container 100 through a port 110 formed in the top of the container 100 and to a vacuum outlet 15 on the vacuum packaging machine 10. Fittings 25 (see also FIG. 4) on both ends of the tubing 20 connect tubing 20 to the port 110 and vacuum outlet 15. A vacuum motor (not shown) in the vacuum packaging appliance 10 generates the necessary suction to evacuate the container 100 when fluidly connecting the tubing 20 to the vacuum packaging machine 10. The container 100 includes an open mouth and a lid 120 adapted to cover the open mouth to define an enclosable chamber or internal volume 150.

In an embodiment, the container 100 may be formed of any suitable material having suitable characteristics for preserving foodstuffs and can be formed into a vessel having an interior volume 150. Typically, materials are selected that have low oxygen transmission rates such as nylon, plastic, glass, etc. Similarly, the lid 120 may be formed of any suitable material having such characteristics. The lid 120 may be formed with threads 122 that engage threads 117 on the neck 115 of the container 100, form fitted, or any other fastening method known in the art. The lid 120 is removably secured to the body of the container 100 for sealing the the container 100 in an air and liquid tight fashion.

Referring now also to FIGS. 3-5, in an embodiment there is illustrated a container 100 having an expandable medium 130 that extends downwardly from the lid 120 into the interior volume 150 of the container 100 that expands as the container 100 is evacuated. The expandable medium 130 aids in evacuating the container 100 by occupying a portion of the interior volume 150 and also provides a visual indicator of the container 100 either being not evacuated or evacuated. As previously described, a port 110 is provided for connecting to tubing 20 for connection to a vacuum source (not shown). The port 110 extends through the sidewall of the container 100 into the interior volume 150 to fluidly connect the interior volume 150 to the vacuum outlet 15 via tubing 20. The expandable medium 130 is comprised of a resilient elastic material formed into a plurality of interconnected gussets 135 that are normally compacted against one another as shown in FIGS. 3 and 4. The material may include plastics such as polyethylene, polyester and polypropylene or nylon. Each successive gusset 135 is smaller in diameter than the next adjacent gusset 135 such that the gussets 135 may be compacted in a first configuration (seen best in FIG. 4) and expanded fully in a second configuration (FIG. 5).

The first configuration is visually observable from the top or outer side of the lid 120 as shown in FIG. 3 where the expandable medium 130 is compacted and substantially disposed within the plane of the lid 120. When suction is applied to the interior volume 150 of the container 100 through the port 110, atmospheric pressure is applied to the outer side of the expandable medium 130 forcing the plurality of gussets 135 to expand into the interior volume 150 which further displaces air within the interior volume 150. The expandable medium 130 also serves as a visual aid to the degree the container 100 is evacuated between the non-evacuated configuration shown in FIGS. 3 and 4 to the fully evacuated configuration shown in FIG. 5. As such, the evacuation of the container 100 may be verified by observing the expandable medium 130 is fully expanded. A pressure discharge valve 112 is disposed adjacent to the port 110 for venting the previously evacuated interior volume 150 into the atmosphere. To vent the interior volume 150 into the atmosphere, the pressure discharge valve 112 is depressed until pressure in the interior volume 150 is equalized with the atmosphere. When pressure in the interior volume 150 is equalized with the atmosphere, the absence of vacuum causes the elastic material comprising the expandable medium 130 to return to the first or compacted configuration shown in FIG. 4. A material is elastic if it is able to return to its original shape or size immediately after being stretched or squeezed. After the interior volume 150 of the container 100 is equalized with the ambient air pressure, the lid 120 can be easily removed for access to the contents of the container 100.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A food preservation container, comprising:
a body including at least one sidewall and having an interior volume;
a lid for removably attaching to the body for sealing the food preservation container in an air and liquid tight manner;
an expandable medium attached to the lid, the expandable medium including a plurality of gussets normally in a compacted first configuration against the lid; and
a port formed in the at least one sidewall configured to connect to a source of suction, the suction for evacuating the food preservation container and causing the expandable medium to expand away from the lid and into the interior volume to an expanded second configuration.

2. The food preservation container of claim 1, further including:
a valve disposed within the sidewall which is depressed after evacuation of the food preservation container to equalize pressure within the interior volume to atmospheric pressure.

3. The food preservation container of claim 2, wherein the expandable medium is caused to return to the first configuration when the valve is depressed and pressure within the interior volume is equalized to atmospheric pressure.

4. The food preservation container of claim 1, further including a neck on the body of the food preservation container having threads that engage complementary threads on the lid configured to seal the lid onto the body.

5. The food preservation container of claim 1, further including:
the expandable medium including a plurality of gussets that are interconnected such that the expandable medium is compacted in the first configuration and expanded in the second configuration.

6. The food preservation container of claim 1, further including the body being visually transparent such the expandable medium is viewable acting as a visual indicator of the food preservation container not being evacuated when in the compacted first configuration.

7. The food preservation container of claim 1, further including the body being visually transparent such the expandable medium is viewable acting as a visual indicator of the food preservation container being evacuated when in the expanded second configuration.

8. The food preservation container of claim 1, further including the expandable medium being viewable from outside the lid such that the expandable medium is a visual indicator of the food preservation container not being evacuated when in the compacted first configuration or the food preservation container being evacuated when in the expanded second configuration.

9. The food preservation container of claim 1, wherein the body of the food preservation container is comprised of plastic or nylon.

10. The food preservation container of claim 1, wherein the source of suction is a vacuum packaging machine.

11. A method of preserving perishable items, comprising the steps of:
evacuating air from a sealed storage container having an interior volume containing a perishable item to be preserved;
expanding an expandable medium into the interior volume attached to a lid of the storage container; and
verifying the storage container has been evacuated by visually observing whether the expandable medium has been expanded into the interior volume.

12. The method of preserving perishable items of claim 11, further including the step of fluidly connecting the storage container via tubing to a source of vacuum.

13. The method of preserving perishable items of claim 12, wherein the source of vacuum is a food storage machine.

14. The method of preserving perishable items of claim 11, further including the step of:
depressing a valve on the food storage container configured to equalize pressure in the interior volume to atmospheric pressure causing the expandable medium to collapse into an compacted configuration.

15. The method of preserving perishable items of claim 14, further including the step of:
verifying the storage container is no longer evacuated by visually observing whether the expandable medium has collapsed into the compacted configuration.
